(19) United States
(12) Patent Application Publication
(10) Pub. No.: US 2011/0288947 A1
(43) Pub. Date: Nov. 24, 2011

(54) METHOD, SYSTEM, AND APPARATUS FOR SOCIAL NETWORK BASED SUPPORT PLATFORM USING CONTENT PACKAGES AND EXPERT INTERACTION

(76) Inventor: Dov BIRAN, New York, NY (US)

(21) Appl. No.: 13/112,421

(22) Filed: May 20, 2011

Related U.S. Application Data
(60) Provisional application No. 61/346,788, filed on May 20, 2010.

(51) Int. Cl. G06Q 30/00; G06Q 50/00

(52) U.S. Cl. 705/26.1; 705/319

(57) ABSTRACT

A computerized system and method for the exchange of information between and/or among instructors and users in a goal-oriented context. Embodiments of the present invention provide systems and methods in which an expert in a given field and/or instructor may interact with one or more users by providing packages and/or lectures, guides, literature, and other content, receiving user questions and input, scheduling and tracking user progress, as well as social interaction among end users. Embodiments of the present invention may also provide an infrastructure that allows for on-line registration and payment for packages and/or subscriptions.

### CROSS-REFERENCE TO RELATED APPLICATIONS

This application claims the benefit of U.S. Ser. No. 61/346,788, filed on May 20, 2010, the content of which is incorporated in its entirety by reference herein.

### FIELD OF THE INVENTION

The present application relates generally to social networking software, products, and services, and more specifically to methods, devices and systems for a social network platform using content packages and expert interaction.

### BACKGROUND OF THE INVENTION

Computer networks, typically including at least one server and a plurality of clients connected thereto, are increasingly being used to construct social networks, in which users log in and are provided with various tools for connecting and interacting with each other. Examples of social networks are Facebook®, LinkedIn®, Twitter® and others. However, to date, social networking websites have generally focused on providing tools for mere online social interaction, with little content or utility in the real world.

### SUMMARY OF EMBODIMENTS OF THE INVENTION

According to embodiments of the present invention, there may be provided a system including a server configured to be accessed over a network by a plurality of users using client computers, the server being associated with a processor and a database, wherein the database is configured to store a plurality of content package data templates, and wherein the processor is adapted to: provide a plurality of content package templates for selection by a user, each content package template including at least one task field and a timing field associated therewith, receive a selection by a user of a content package template, customize the selected content package template by populating at least one timing field in the selected content package template based on target timing information, store the customized content package in the database in association with the user, and provide an interface for the user to interact with the customized content package.

A method according to an embodiment of the invention may include providing over a network a plurality of content package templates for selection by a user, each content package template including at least one task field and a timing field associated therewith; receiving a selection by a user of a content package template; customizing the selected content package template by populating at least one timing field in the selected content package template based on target timing information; storing the customized content package in association with the user; and providing an interface for the user to interact with the customized content package.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a system including a server and clients communicating via a network according to an embodiment of the invention;

FIG. 2 is a schematic diagram of the various types of users, and their modes of interaction according to embodiments of the invention;

FIG. 3 depicts an exemplary screen shot showing construction of a new content package according to an embodiment of the invention;

FIG. 4 depicts an exemplary screen shot of a content package store 30 according to an embodiment of the invention;

FIG. 5 which is a generalized schematic screen shot of a web page provided at a client computer according to an embodiment of the invention;

FIG. 6 depicts an exemplary home page of a web site according to an embodiment of the invention;

FIG. 7 depicts an exemplary content package in expanded form according to an embodiment of the invention; and

FIG. 8 depicts a schematic figure of modules in a server used by a system according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The present invention relates generally to systems and methods for the exchange of information between instructors and users, and among users, in a goal-oriented social network context over a network, e.g., the Internet, and the use of a novel type of digital media for scheduled activity delivery. More specifically, the present invention relates to systems and methods in which an expert and/or instructor in a given field may interact with one or more non-collocated user by providing one or more package, lecture, guide, literature, and/or other materials, as well as receiving user questions and input, and conducting participatory discussions using the Internet. In addition, the present invention allows users having common goals, packages, instructors, interests, challenges, etc., to communicate based on such packages. The present invention provides an infrastructure that allows for on-line registration and payment for packages and/or subscriptions, and a business method for employing the above.

Described are a system and method for providing to a community of users access to an electronic market of packaged online content. A system according to embodiments of the invention may include a server computer accessible and/or in communication with a plurality of user computers over a network. A user computer may be associated with a user of the system having predefined characteristics indicative of a predetermined role in the system, e.g., a user, an expert, etc., as discussed below. User roles provide a level of access to data files associated with a package, and a level of control over data files associated with the package. The server computer may include or be associated with a storage for storing data files associated with packages, and a processor for assigning a level of access to each file, wherein the level of access may be associated with the ability of a user to access, modify, or otherwise manipulate the file, determining an access level of a user requesting access to any file, determining whether to allow access to a file associated with a package as a function of the access level of the user, and if such access is allowed, then permitting the requisite access.

Embodiments of the present invention involve methods, systems, and services for working with content packages, intended to help users accomplish goals in a social network setting. Achieving life goals may require a set of packages with specific action items, scheduling, measurement, and reporting mechanisms, and motivation to perform in a timely manner. According to embodiments of the present invention, goals may be user defined, or the user may be inspired by goals that other users have undertaken, or the user may be provided with a content package by an expert instructor, who has laid out a schedule for achieving goals based on action items.

It is a general object of the present invention to provide a system and methods that allow users to interact with a computer network-based support system through means of a simplified, easy-to-use user interface with experts and/or other users. A further general object of the present invention may be to provide a system and method that can accommodate a variety of diverse engagement modes without requiring substantial modifications to any user's computer system. A further object of the invention may be to provide such a system that allows multiple types of users to access the features of the system as a function of their predefined role within the framework of the system. It is a further object of the invention to provide such a system that integrates with the platform provided therein value added services and control such as calendars, plans, lists, contact integration and interactive communication functions. Any one or more of these objects may be fully or partially satisfied by embodiments of the present invention. Other objects may be apparent based upon the present specification, including the drawings and appendices attached hereto.

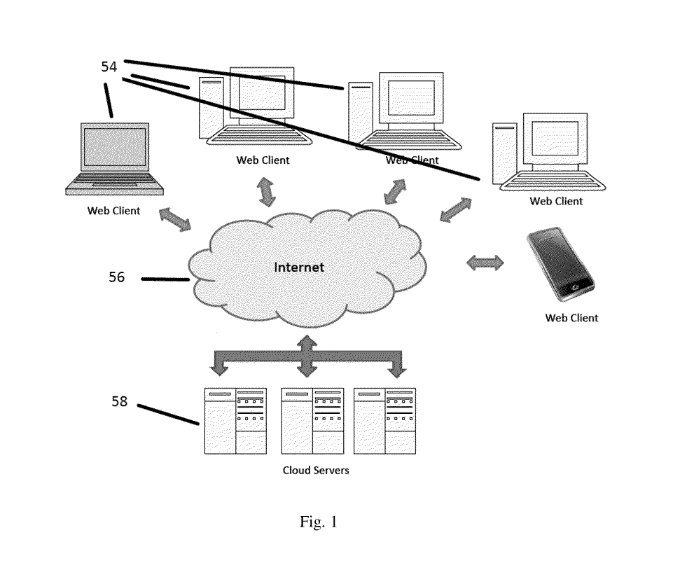

FIG. 1 is a schematic depiction of a system according to an embodiment of the invention. Users (including any type of user, as described below) may access the server, e.g., a cloud server 58, over the internet 56, using any type of computing device 54 having thereon software enabling Internet connectivity, e.g., a web browser. As discussed further below, the server may provide a graphical user interface for interacting with a content package and with other users. The server may further be associated or in communication with a database that includes a repository of available content packages (e.g., a content package store), and actual deployed content packages of users, including schedules, tasks, etc., as described below.

According to embodiments of the invention, users may have one or more predefined roles. It will be understood that a user may have more than one role, based on the content package at issue.

According to an embodiment of the invention, a basic role may be that of a standard user (also referred to generally as a user). Upon registration to the system, the standard user may have the ability to create packaged content for his/her own use, communicate with other users, add other users as friends, serve as a collaborators and motivator (explained below), and purchase expert-created digital content, and other expert services. Some users may be standard users in addition to having other or additional roles, as described below.

An expert user (also referred to as an expert) is a user approved by the system administrator as an expert in his/her field of work. An expert may have substantially all of the abilities of a Standard user, as well as the ability to create packaged digital content for the purpose of selling it, e.g., distributing it for a fee to be charged by the system administrator or directly, and/or the ability to provide expert services for a fee. There may be different types of expert services, including but not limited to: (1) real-time video, audio, or text communication with standard users; (2) messaging through the system, e.g., real-time chat or VoIP, or instant messaging, or non-realtime messaging such as electronic mail, (3) content monitoring, in which the expert and user have the same copy of packaged content and may interact thereon, and (4) off-line services administered by the expert outside of the system, but billed and processed by the system.

Experts may be members of one or more organizations. Organization experts are members or representatives of a company or institution, e.g., an online school, and may assign tasks and actions to users of that organization's packaged content. For example, if a local gym wants to host a presence on the system, it can hire trainers to serve as its experts for its organization. Packages created by organization administrators can be made available only to invited users, or made otherwise invisible to the public. Organizations may encompass or include roles in other than or in addition to expert roles of their members, including: (1) an organization Administrator, who may control who may be an expert affiliated with the organization, and who may be a user of the organization's packages and services; (2) a Site Administrator, who may have control over the organization's presence; (3) a content administrator, who may have administrative control over a certain package of content, instead of or in addition to an expert. The system according to the present invention may provide extended administrative tools for creating, publishing, executing and monitoring packaged content in an organizational context. These include, but are not limited to, attaching multiple experts to a certain package, structuring a standardized approval process for publishing packages of content, and inviting users to join certain packages, etc.

The system may provide experts with the ability to update their packaged content and republish it, thus creating updated versions of the package. Users who have acquired the package may be notified when a new version is available and will have the option of updating their package (which they are already using), and continue working on it. In some embodiments, for the sake of continuity and maintaining the integrity of the original version of the package, the system may limit the expert in the number or the kind of changes that he/she may make to packages that have already been published and acquired by users.

A motivator may be a standard user (or an expert user who is acting in his or her standard user account), who may be invited by another user (or an expert) to track that users' progress through content, and communicate with that user and other motivators in order to offer encouragement and advice. A motivator may be given certain levels of access to the user's content and progress beyond other standard users.

A collaborator may be a standard user (or an expert user who is acting in his or her standard user account), who may be invited by another user to help achieve goals or packages by completing tasks that are assigned or co-assigned to the collaborator. Collaborators may be working on the same copy of the package as other users. Collaborators may be assigned tasks to complete on their own, or may be given rights to work on shared tasks with other users. In the event a project is computer-based, the system may provide collaborators with online access to project content in a data storage associated with the system.

According to embodiments of the invention, the structure of interactions among users, motivators, collaborators, and experts is described based on a content package or package of digital content that may be obtained by a user, for example, created by the user or purchased from an expert from an online store.

Generally, a content package may be a data structure including a set of database entries that contain an organized set of tasks created to help users structure their effort, track their progress, and thereby achieve their goals. Generally, a content package template may include tasks, each including one or more fields, including a timing field, and the relationship between the tasks and the fields. There may also be copies or instances of content packages, in which the fields in a content package template are filled in or populated with values, e.g., measurements, goals, dates, etc. A copy of a content package template may be made, the fields populated with values based on a particular end user, and the copy stored in a database in association with the user's account, and accessible to the user using an interface, such as described herein.

According to embodiments of the invention, content packages may comprise one or more tasks, and each task may comprise one or more fields. Fields may correspond to physical or other actions that users must perform and then report on, files that the user must upload, information that the user must read or otherwise consume, or other communications. Tasks and fields may be recurring, or may be specific to one occurrence. Recurring tasks and fields may be set to repeat on certain days of the week, or repeated a predefined number of times over a predefined length of time. Single-occurring tasks or fields can be scheduled to occur between certain dates, on a certain date, after a certain date, or before a certain date.

In the below description of the creation of a content package, reference is made to a creating user and an end user. The creating user may be provided with the ability to create a content package, and may be a standard user creating the content package for himself (i.e., the creating user and end user are the same), or an expert constructing the content package for the purpose of publishing and selling the content package for an end user to purchase and achieve a goal (i.e., the creating user and end user are different). The features available to the creating user in the process of building, publishing and monitoring the packaged content may depend on his/her role and may be limited by a higher role, e.g. an organization administrator may limit the capabilities of the site administrator in his/her organization, etc.

In accordance with these functionalities, objects, and components, expert or non-expert users may create packages. In order to create a package, users may interact within predefined categorical parameters to personalize and share their own packages with other users. Within the confines of these categories, users may define the parameters that are required for the construction of a useable and coherent package, including achievement validation and Calculators. Media components such as video, audio, presentations, interactive graphics may be embedded in the package to enhance and better articulate the substantive and introductory content contained in the action.

Content packages may be unscheduled or scheduled. An unscheduled content package may be a step-by-step package, according to which tasks need not be associated with times or dates, but rather are performed in a predetermined sequence. Therefore, upon completion of a first task in the content package, the content package will prompt for a second, subsequent task. A scheduled content package may define the various tasks in association with respective dates, e.g., a date on which a task must be performed, started, completed, etc. When creating a new content package, the creating user may have several options of scheduling types for the entire package, which may affect the end user's scheduling of the content package. The scheduling type may determine how the end user's specific copy of the content package will be scheduled, and the kind of manipulation the end user can effectively perform on the scheduling. The previously mentioned options for scheduling individual tasks and fields may depend on the scheduling type of the entire content package. Which of the below scheduling types are available to a creating user may depend on his/her role in the system. As discussed below, scheduled content packages may be created based on a relative or absolute scheduling scheme, or a combination thereof.

If the creating user chooses to construct the content package as a relative schedule, then tasks in the content package, including timing fields associated with the tasks, may be populated with dates scheduled to occur in relation to a designated date on which the end user may choose to begin or end the package. For example, if the packaged content contains a task that must be performed on the 17th day after the packaged content has started, and the end user chooses to start the packaged content on May 3, then the timing field of that task would be set to appear (in connection with that specific end user's copy of the content package) on May 20.

If the creating user chooses to construct the packaged content as an absolute schedule, then at least one task or field may be scheduled to occur on a specific date (e.g., defined by specific day, month, and year), and the end user may not be given the ability to control the scheduling of such absolute dates. It will be understood, as described below, that a content package may have one or more absolute dates, but that other dates in the package may be relative. For example, a content package to prepare an end user to prepare for a specific marathon (e.g., the New York marathon, to be held November 6), then the race day may be an absolute date, but some dates for training may be relative to when the end user chooses to start training.

If the creating user chooses to construct the packaged content with no scheduling, the tasks and fields need not be associated with any time constraints.

When fixed, the dates in a content package schedule indicate when tasks should be performed. It will be understood that while reporting may be required, the user may report progress for a scheduled task or field on a day other than the day the task or field is scheduled. For example, if a task is scheduled to occur on Monday and Wednesday, the user may choose to report progress on both tasks on Thursday. Depending on the configuration of the content package, a user may be permitted to duplicate, reschedule, defer, or dismiss specific tasks and fields as desired.

The creating user may add various fields related to a task for the end user to fill in upon completion (or non-completion, as the case may be) in accordance with the previously mentioned scheduling types and options. These fields may be able to hold input types including (but not limited to) textual input, numerical input, video upload, sound upload, and other types of file uploads, multiple-choice selectors (as dropdowns or graphical sliders), or a combination of the above.

According to embodiments of the invention, numerical input fields, e.g., measurements, may be predefined by the system and creating users may be allowed to customize the content package so as to specify the manner in which such numerical fields appear in the end user's interface. Measurements may be classified as part of a “measurement groups” data structure and/or related rules, which define and maintain the ratio between the different measurements. For example, “Inches”, “Feet” and “Miles” are measurements, which are part of the “Imperial Distance” measurement group. Embodiments of the system may define in that particular measurement group that 12 “Inches” are equal to 1 “Foot”, and that 5,280 “Foot” are equal to 1 “Mile”. The creating user may choose to provide the end user with a customized set of measurements (thus creating a measurement structure). For example, the creating user may choose to create a measurement structure of (A) “Miles” and “Inches” or (B) “Yards” and “Feet” etc. The system may also offer the creating user a set of predefined common measurement structures to easily implement as part of the content package. Measurement structures may be stored together in the database and treated as a single unit when analyzing data and generating visual reports.

The creating user may be provided with tools to create calculator programs or sub-routines (referred to generally herein as “calculators”) within the content package, which may be or use mathematical expressions that make use of one or more measurement structures (as defined by the creating user) and output a numeric result. The definition of these calculators by the creating user may allow him/her to choose the span of data to be taken into account, e.g., data from a past number of sessions/days/weeks/months/years/etc. Calculators may also make use of non-measurement (non-numeric) data such as multiple-choice fields, the number of completed tasks by the end user etc. to generate numeric data to be included in the expression. For the calculated result, the creating user may define a custom unit or use one of the predefined measurements in the system, as well as apply a final conversion to a different Measurement Structure. Calculators, once created, may function as measurement structures, allowing the creating user to use them in other calculators and the end user to view visual reports and data output generated by the system. According to some embodiments of the invention, calculators may be saved by a creating user, for example, as a preset, which may be used or reused in connection with other content packages created by the same creating user. The system may therefore provide a plurality of end users with calculators by the creating user of content packages that they have downloaded.

For the end user, the system may provide an interface, which may display these Measurement Structures in an organized manner. The system may perform on-the-fly conversions within the Measurement Structure and calculations within calculators as the end user types in data.

In addition to creating measurement structures and calculators, and in correlation with their defined arrangement, the creating user may assign specific numeric values to be validated, in order to ensure the achievements of the end user. These may be defined using specific values, a range of values, maximum value, and/or minimum value which must be reported by the end user at a defined or undefined time (corresponding to the scheduling type of the content package). For example, the creating user may decide that the end user must reach such predefined values in order to complete the content package or to advance from one task or level to a next one. The system may provide a graphical user interface, which may alert the end user when he/she has met the required value as well as a mechanism to notify other relevant users in the system of the achievement (or the lack of one).

According to some embodiments of the invention, using motivational analytics, the system may analyze the user's progress through his or her chosen package and adjust the package and the package's communications to be more effective. In some embodiments, this may be done by collecting the package data input by the user, analyzing the trends, comparing them to an expected progress provided by the package's creating user, end user's ability to meet the achievement validation values and taking into account future packages. In some embodiments, the system may analyze past performance of other users of the same package, for example, having similar goals, or demographics, or other common features, and calculate an expected progress. The system may extrapolate the data and alter the current package automatically to accommodate the user's goals. The system may suggest based on such analysis other packages that the user may want to use. Notifications and “system rewards” may be provided to the user based on behavioral economics principles, such as comparing the user's progress through the package with other users' progress through the same package. The system may synthesize all data available from the user and other users to determine whether a user is “on track” or “falling behind” and notify relevant users (such as motivators or expert).

As noted herein, according to embodiments of the invention, packages may be created by a user for his/her own use, and/or by an expert (including an organization) for use by other users.

User-created packages may be created by a user for personal use, or to share with another user, for example, a friend, etc. The user may have complete freedom to edit the packages created by him/herself or another user. For that reason, in some embodiments of the invention, user-created packages may be built using only absolute scheduling. The user may have the ability to reschedule any or all of the tasks contained within the package. When the user shares the package with another user, the system translates it into a relative scheduling package, which allows the user who receives the package to determine when it will start or end. A copy of the package is created for the receiving user, who becomes the owner of the package and can alter it and share it with more users. Typically, user-created packages will not be made available for sale, and the system will not charge for use or sharing of a user-created package.

Expert-created packages may be created by experts for the purpose of selling on the system, or assigning them to a specific user or group of users. Some expert-created packages may be open for editing by the end user, while others are not open.

With regard to individual content packages, an expert may create packages with the above-mentioned features and publish them in the system's market, thus allowing users to purchase of otherwise acquire and use packaged content. The acquisition by the user may create a copy of the packaged content to be used by that specific user, allowing him/her to invite motivators and collaborators. In some cases the expert who created the package (or any higher role in the organization which the expert is a part of) may limit the number or motivators or collaborators that are allowed for that package. The package may include expert services either as built-in elements to the package (and acquired along with the entire package) or added later on. Users may invite experts to monitor their individual progress on their copy of the packaged content. The user and the expert may be allowed to edit and change the packaged content, although the system and/or higher roles in an organization may limit this ability. The expert may choose to create updated versions of the package and the system will notify existing users of their ability to update the package.

With regard to group class expert-created content packages, the expert may create and publish packages that take form of group classes. In this case the expert may define and limit the schedule for registering to the package, number of students, prerequisites and other crucial parameters for the package to be suitable for a group. Users may join or register for the package content and an instance (not an individual copy) of the package is created for their account. Users can then use the package to follow the content, tasks and report to the fields assigned by the expert. For example, an English class taught by an English teacher (the expert) can have up to 10 students (users). All users have to read one article per day as a task and all of them must turn in an essay once a week—these are defined as tasks and fields in the system that all users perform individually, but in a group environment, allowing the expert to monitor them together.

According to embodiments of the invention, the system may provide both personal and general areas, allowing users to monitor their own progress, as well as be exposed to others in a group class. The amount of privacy and exposure depends on an organization's preferences, the expert's preferences and the individual user's preferences. The expert, organization and its different administrators may be provided with tools to monitor the package for the entire group as a whole and/or for individual users. The system may provide administrative tools to add or remove users from the package, change the content of the package (including tasks, fields and scheduling), create announcements regarding the package, comment on the activity of the package etc. before or after it has started and users are using it. Users may invite motivators on this type of package content, although different kind of exposures may be imposed on this type of package due to privacy of the other users (other class members). In particular cases, the system may allow users to edit or change the scheduling for their instance of the package without affecting other users.

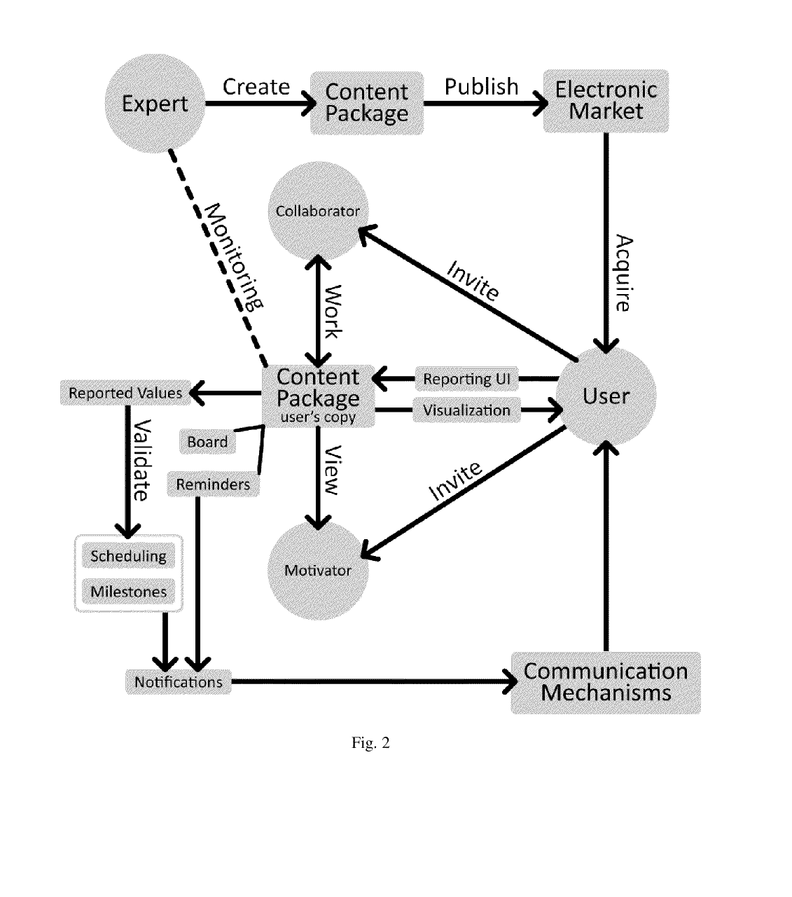

Reference is made to FIG. 2, which is a schematic diagram of the various types of users, and their modes of interaction according to embodiments of the invention. An expert may create a content package, which may be stored on a database associated with a network server. The server may publish content packages by making them accessible to users on a website that functions as an electronic marketplace (also referred to as a content package store). Users may acquire content packages from the electronic marketplace. In cases where users pay for such content packages, there may be an agreement between the network operator and the expert on how the fees for each content package are to be divided. In other instances, the network may charge the expert a flat fee for making the content package available on the electronic marketplace. Once acquired by the user, the network may make a user's copy of the content package, and populate it with information relevant to the user, e.g., specific goals, absolute and relative target dates, etc. The user's copy may be stored in a database in association with the server for being viewed or accessed by the user over a network and updated by a user interface at the user's client computer.

A user may invite one or more collaborators or motivators. As discussed herein, collaborators may work together with the user on tasks in the user's content package, and motivators may view the user's content package. In addition, where relevant, the expert originating the content package may monitor a user's progress with respect to tasks and goals in the content package.

The user's copy of the content package may generate various action items. For example, when a user reports progress with respect to certain tasks, values provided may be validated. If suitable, these may be used for scheduling of further items, numerical value validations, etc., which may be used to update the user's copy of the content package. The user's copy of the content package may generate items to be posted to the user's “board” on the website, for other users to view (based on the user's preferences). In addition, notifications may be generated, for example, in response to reported values and/or based on reminders in the user's copy of the content package. Notifications may be issued to the user by way of various communication channels, as established by user preferences, e.g., by email, SMS, automated phone call, etc.

According to an embodiment of the invention, an interface may be provided for creating content for personal use and/or for sale to users. Text instructions created by the creator may be annotated with digital photos, digital videos, or sound recordings. This interface may allow the creator to assign several scheduling schemes to the encapsulated task.

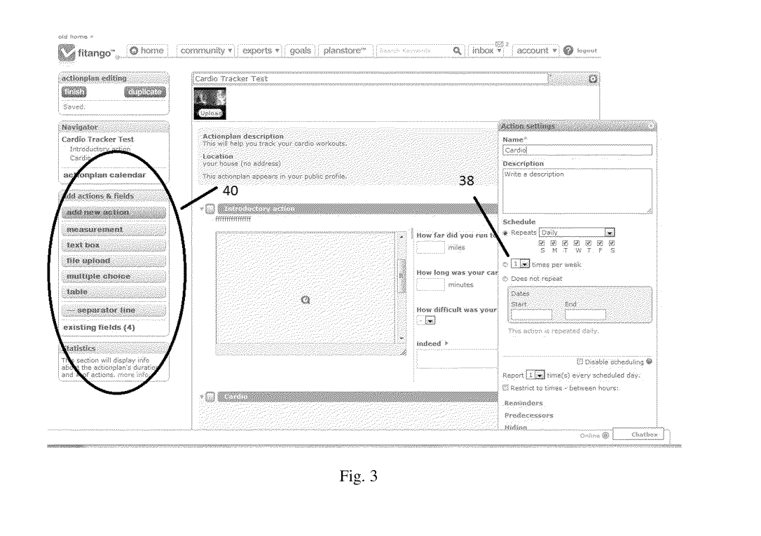

FIG. 3 depicts an exemplary screen shot showing construction of a new content package according to an embodiment of the invention. The content package may include a title (“Cardio Tracker Test”), a description (“This will help you track your cardio workouts”), a location (“your house”), and whether the content package is public or private. Each task or action may be associated with a plurality of fields, including a description (e.g., using text, a video, or other content), input information (e.g., distance, time, level of difficulty, free text for comments), and settings 38 such as scheduling information (e.g., repetition information, reporting timing, reminders, etc.) Other actions and fields may be added by the creating user in a simple graphical user interface 40. Any of these fields may be set by the creating user. According to embodiments of the invention, data may be collected from end users who downloaded the package and provided to the creating user (e.g., expert).

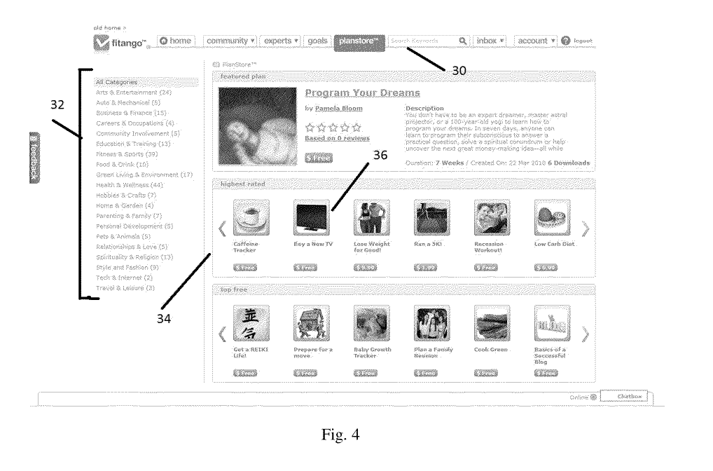

When completed, particularly by an expert creating user, a content package may be uploaded to a server and made available to be purchased through a content package store. FIG. 4 depicts an exemplary screen shot of a content package store 30 according to an embodiment of the invention. The available content packages may be grouped into categories 32 for browsing. Content packages may be rated by users, and ranked by highest rating 34. Content packages may also be filtered based on cost of downloading the content package, e.g., free content packages. Some content package sellers may pay for their package to be featured in a larger area of the store browsing area. Upon selecting a content package icon 36, the system may provide information about available content packages, such as a title, author, image, description, duration, user ratings, comments, etc.

When a user decides to purchase or otherwise acquire a content package, the system may make a copy of the content package package content for association with the user, and place that copy in an area of a database accessible only to that user, and/or to other users as specified. Once the package is created, the system can be instructed to notify the user when he or she has upcoming tasks to accomplish. A user may configure a profile to provide for notification mechanisms to utilize one or more of multiple communication mechanisms, e.g., SMS messaging, E-mail messaging, electronic instant messaging, social network messaging, etc.

According to embodiments of the invention, users may assemble around common interests to form groups. Users in groups may work as members of a group package, according to which each member of the Group may have their own copy of the package, and all of the Group members may work through the package on their own, while interacting with other Group members who all want to achieve the package's objective. For example, a book club may list as tasks books to be read by the group, a schedule for each book, and provide for users to provide comments during or after the books are read.

In some embodiments of the invention, users of an individual (non-group) package may be placed by default into a subset of users who are also using that package, for example, concurrently, or within a window of time. Users in the subset may communicate with each other, offer encouragement, and compare progress, etc. According to embodiments of the invention, the users need not be acquainted, but rather the system may make communication between and among the users having a common package available. The system may offer certain additional filters, for example, users of the package with a similar date range of their goal, or certain demographics, etc.

The system may provide a graphical user interface to manage, organize, and edit packages in a structured manner. In a monthly view, for example, users may see a visual representation of their packages on a monthly basis, and may easily re-order their actions, edit actionable items, and change scheduling options using a simple and intuitive interface. A daily view may display the user's actions for a particular day in a visual manner, and summarizes important data such as completed actions, actions which have yet to be completed, completed packages in the dashboard section. It will be recognized that the views may include tasks and actions from a plurality of packages or packages of a particular user, and information about other users with whom the user is involved, e.g., a milestone of another user to whom the particular user is a motivator or collaborator. According to some embodiments, users may generally be limited or precluded from distributing packages they create with the entire community; however, in some embodiments, users may be allowed to share their created packages with friends, or other users of direct relation, who may obtain copies and modify them at will, as if created by an expert.

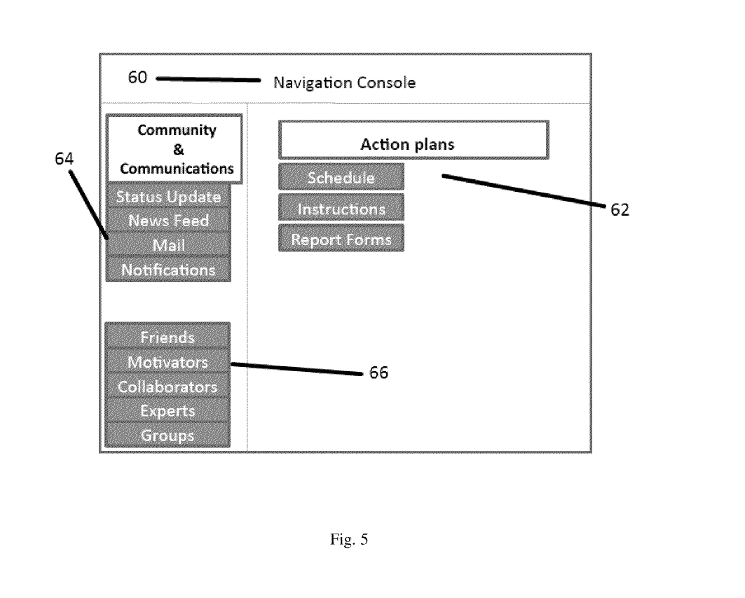

Reference is made to FIG. 5, which is a generalized schematic screen shot of a web page provided at a client computer according to an embodiment of the invention. The navigation panel 60 at the top of the screen allows the user to navigate to various areas of the web page. The user's current content packages may appear in a main user panel 62, each package including a schedule, instructions, and report forms. The system may provide designated areas for the user and his/her motivators to interact within the packaged content. For example, communications from other users and system messages may be displayed on the left side of the screen 64, including status updates, new feeds, mail, and notifications. Screen area 66 shows other users or sources of messages and information, including friends, motivators, collaborators, experts, and groups. The system may notify all users involved in the specific package (users, experts, motivators and collaborators) of the social conversation that is developing within the package, according to individual preference.

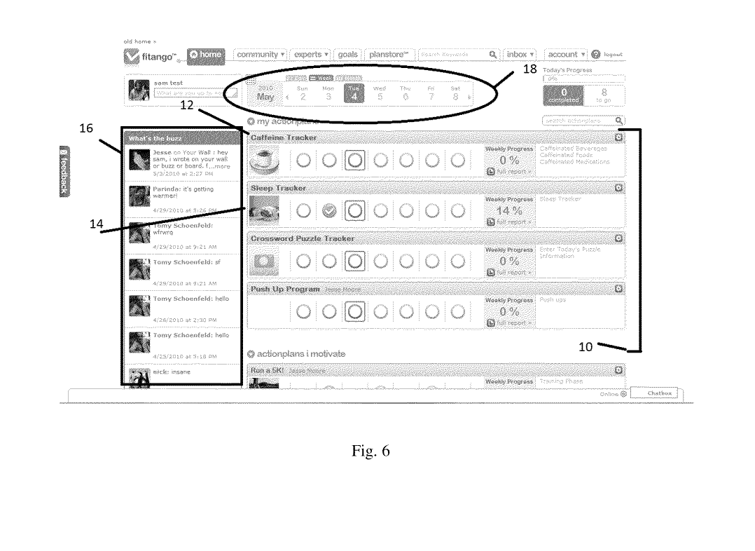

Reference is made to FIG. 6, which shows an exemplary home page of a web site according to an embodiment of the invention. The home page may present the user's downloaded and user-created content packages in a main user panel 10, e.g., Caffeine Tracker 12, Sleep Tracker 14, etc. A home page may also include a dynamically updated list of information about the user's friends 16 (e.g., status reports, etc.), as well as a weekly overview of all actions to be completed this week 18.

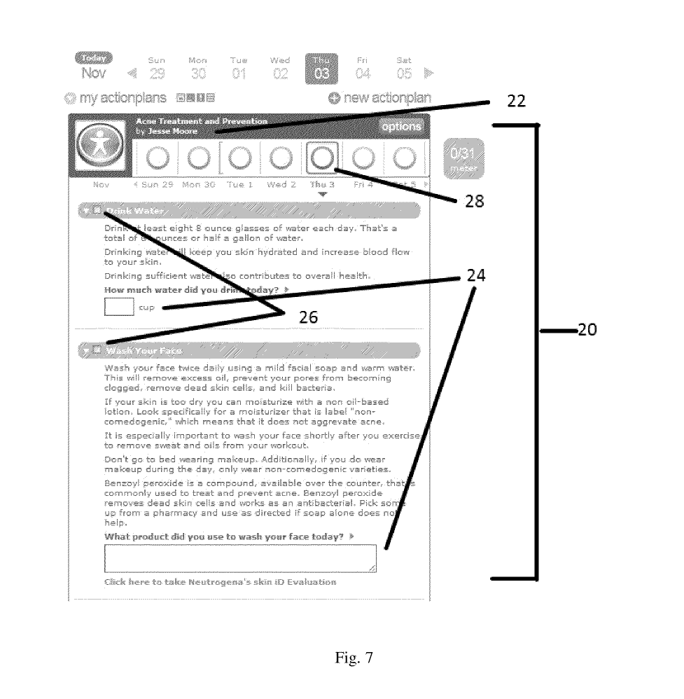

Reference is made to FIG. 7, which depicts an exemplary content package in expanded form according to an embodiment of the invention. In this expanded view 20, the actions for the day may be explained in some detail by the author of the package, e.g., Jesse Moore 22. As the user completes the day's actions, the user may be asked to input certain data 24, for example, in text boxes. When the user completes the actions for the day, he/she may check the box next to the action title 26. Checking the box may automatically cause the system to fill in the circle for the current day 28, indicating partial or complete progress through the content package for that day.

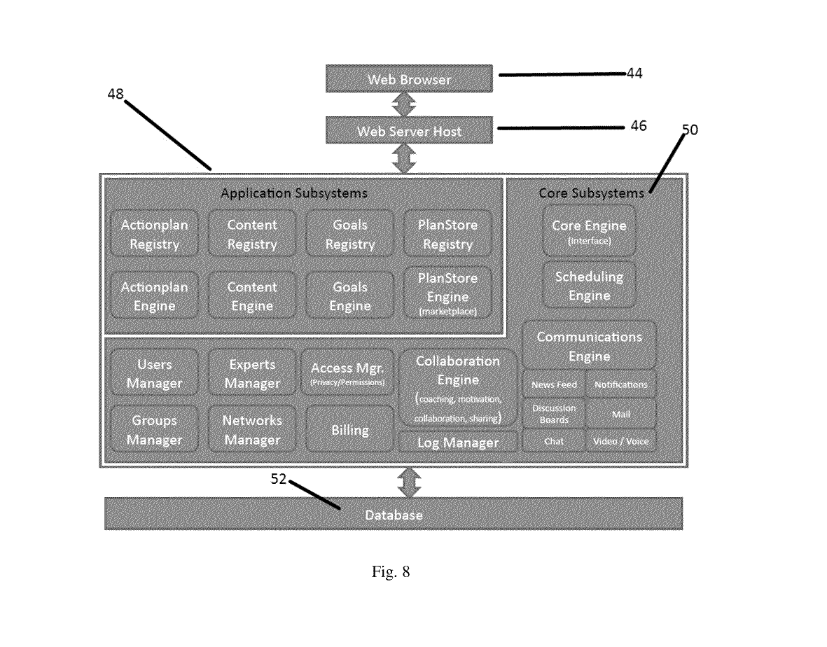

Reference is made to FIG. 8, which depicts a schematic figure of modules in a server used by a system according to embodiments of the invention. Users having a browser 44 may connect to a network (e.g., the Internet) via web server host 46, and access certain application modules or subsystems 48 and core modules or subsystems 50, which may retrieve and/or save data to database 52.

Core sub-systems may include an interface engine to provide the interaction between the user and the system; a scheduling engine to create and/or execute timed schedule items; an experts manager for system relationships with experts, a networks manager, users manager, and groups manager; an access manager to govern privacy and permissions; a billing module to make and accept payments; a collaboration engine for users to work with other users, a log manager; and a communications engine to generate communications with a user (e.g., using news feeds, notifications, discussions boards, email, chat, voice, video, SMS, etc.). Application subsystems may include pairs of registry and engine subsystems to register items and execute them, respectively. For example, the system may include a content package registry and engine; a content registry and content engine; a goals registry and a goals engine; and a content package store registry and content package store engine (marketplace).

A system according to embodiments of the present invention may support third-party hardware and may provide an application protocol interface (API), which may be used to integrate third-party products, such as heart rate digital monitors, or other devices. The data from these devices may be programmed to correspond with certain measurements that report to the package. This may also enable the system to be linked with other systems and online stores (such as merchants of digital media) to create wishlists associated with certain packages, and the user's accomplishments. For example, an API may be used for a motivator to commit to purchasing an item from a merchant website, e.g., amazon.com, which purchase may be triggered upon the user's completion of a stated goal. Integration of scheduled actions can be done with other scheduling products such as Google® Calendar, Apple® iCal, Microsoft® Outlook®, etc. using the standard protocols for exchanging data of this nature.

The system according to embodiments of the present invention may allow the embedding of content into other websites, such as personal blogs, social media, and corporate websites as a publishing tool. The user can customize the nature of the data and the design in order to better fit the “look and feel” of the designated website. Individual parameters may be published with a one-click interface to connected social media accounts, e.g., facebook connect, etc.

The system according to an embodiment of the present invention may provide a “bulletin board” page to accumulate relevant data for the specific user: updates, comments, changes, achievement validation approaching, achievement validation reached, completion of tasks, packages the user is personally working on, motivating on, and collaborating on. The bulletin board may be updated in real time and show links to the different spaces of the sites, redirecting the user with a single click to the area of interest.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system comprising:
a server configured to be accessed over a network by a plurality of users using client computers, said server being associated with a processor and a database,
wherein said database is configured to store a plurality of content package data templates;
wherein said processor is adapted to:
provide a plurality of content package templates for selection by a user, each said content package template including at least one task field and a timing field associated therewith,
receive a selection by a user of a content package template,
customize the selected content package template by populating at least one timing field in the selected content package template based on target timing information,
store the customized content package in the database in association with the user, and
provide an interface for said user to interact with the customized content package.

2. The system of claim 1, wherein the selected content package template comprises a final goal and a plurality of intermediate tasks, each said intermediate task associated with a relative timing field defining a timing relative to the final goal.

3. The system of claim 2, wherein said processor is adapted to customize the selected content package template by:
obtaining from the user a completion date,
populating a timing field associated with the final goal with the absolute completion date, and
populating timing fields associated with the intermediate tasks based on the respective relative timing fields and the absolute completion date.

4. The system of claim 1, wherein the selected content package template comprises a plurality of tasks, each said task associated with a relative timing field defining a timing relative to a start date of the content package.

5. The system of claim 4, wherein said processor is adapted to customize the selected content package template by populating the relative timing fields associated with the plurality of tasks based on the current date as the start date.

6. The system of claim 1, wherein said processor, upon receiving a selection by a user of the content package template, is configured to charge a subscription fee from said user.

7. The system of claim 6, wherein said processor, upon charging a fee from said user, is configured to pay a portion of said subscription fee to a publisher of the selected content package template.

8. The system of claim 1, wherein said processor is further configured to provide at least one publisher with an interface to build content package templates.

9. The system of claim 1, wherein said processor is configured to provide said interface for the user to interact with the customized content package by prompting a user to enter a result parameter for a respective task associated with the customized content package.

10. The system of claim 9, wherein the result parameter is selected from the group consisting of: a binary parameter, a number, a free text field, and a multiple choice parameter.

11. The system of claim 9, wherein the processor is further configured to dynamically modify the customized content package based on the result parameter.

12. The system of claim 1, wherein the processor is further configured to send notifications to the user based on tasks associated with the customized content package.

13. A method comprising:
providing a plurality of content package templates for selection by a user accessing the computer server via a network, each said content package template including at least one task field and a timing field associated therewith;
receiving a selection by a user of a content package template;
customizing the selected content package template by populating at least one timing field in the selected content package template based on target timing information;
storing the customized content package in association with the user; and
providing an interface for said user to interact with the customized content package.

14. The method of claim 13, wherein the selected content package template comprises a final goal and a plurality of intermediate tasks, each said intermediate task associated with a relative timing field defining a timing relative to the final goal.

15. The method of claim 14, further comprising customizing the selected content package template by:
obtaining from the user a completion date,
populating a timing field associated with the final goal with the absolute completion date, and
populating timing fields associated with the intermediate tasks based on the respective relative timing fields and the absolute completion date.

16. The method of claim 13, wherein the selected content package template comprises a plurality of tasks, each said task associated with a relative timing field defining a timing relative to a start date of the content package.

17. The method of claim 16, further comprising customizing the selected content package template by populating the relative timing fields associated with the plurality of tasks based on the current date as the start date.

18. The method of claim 13, further comprising, upon receiving a selection by a user of the content package template, charging a subscription fee from said user.

19. The method of claim 18, further comprising, upon charging a fee from said user, paying a portion of said subscription fee to a publisher of the selected content package template.

20. The method of claim 13, further comprising providing at least one publisher with an interface to build content package templates.

21. The method of claim 13, further comprising providing said interface for the user to interact with the customized content package by prompting a user to enter a result parameter for a respective task associated with the customized content package.

22. The method of claim 21, wherein the result parameter is selected from the group consisting of: a binary parameter, a number, a free text field, and a multiple choice parameter.

23. The method of claim 21, further comprising dynamically modifying the customized content package based on the result parameter.

24. The method of claim 13, further comprising sending notifications to the user based on tasks associated with the customized content package.
